(19) United States
(12) Patent Application Publication
(10) Pub. No.: US 2021/0285333 A1
(43) Pub. Date: Sep. 16, 2021

(54) METHOD FOR CHECKING A CONTINUOUS-FLOW MACHINE

(71) Applicant: Siemens Aktiengesellschaft, Munich (DE)

(72) Inventors: Henning Almstedt, Mulheim an der Ruhr (DE); Ralf Bell, Mülheim an der Ruhr (DE); Ulrich Beul, Essen (DE); Kai Brune, Rheinberg (DE); Robin Burzan, Mülheim an der Ruhr (DE); Matthias Heue, Bochum (DE); Benedikt Hofmeister, Mülheim (DE); Mario Koebe, Mülheim an der Ruhr (DE); Michael Löhr, Mülheim an der Ruhr (DE); Stefan Riemann, Kaarst (DE); Andreas Schaarschmidt, Essen (DE); Andreas Ulma, Mülheim an der Ruhr (DE); Sebastian Zahn, Karlsruhe (DE); Gerta Zimmer, Mülheim an der Ruhr (DE)

(73) Assignee: Siemens Aktiengesellschaft, Munich (DE)

(21) Appl. No.: 16/621,174

(22) PCT Filed: Apr. 20, 2018
(86) PCT No.: PCT/EP2018/060152

§ 371 Date: Dec. 10, 2019

(30) Foreign Application Priority Data
Jun. 20, 2017 (EP) 17176831

(51) Int. Cl. F01D 11/06; F01K 7/16

(52) U.S. Cl. CPC F01D 11/06; F05D 2260/83; F05D 2260/80; F01K 7/165

(57) ABSTRACT

A method for checking a steam turbine, wherein a first operating variable and a second operating variable are determined, wherein a correlation between the first and second operating variable prevails, and a confidence band having an upper maximum value and a lower minimum value is created, wherein a notification is generated as long as the second operating variable is outside the confidence band during operation.

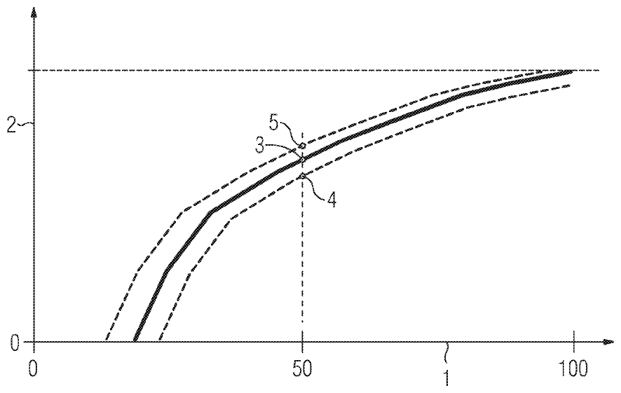

### CROSS REFERENCE TO RELATED APPLICATIONS

This application is the US National Stage of International Application No. PCT/EP2018/060152 filed 20 Apr. 2018, and claims the benefit thereof. The International Application claims the benefit of European Application No. EP17176831 filed 20 Jun. 2017. All of the applications are incorporated by reference herein in their entirety.

### FIELD OF INVENTION

The invention relates to a method for monitoring a continuous-flow machine and a system for performing the method for monitoring a continuous-flow machine.

The invention relates to a method for monitoring a continuous-flow machine, in particular a steam turbine.

The invention furthermore relates to a system for performing a method for monitoring a continuous-flow machine, in particular a steam turbine.

### BACKGROUND OF INVENTION

Continuous-flow machines such as, for example, steam turbines are currently operated individually after they have been put into service. The steam turbines are thus subject to different stresses and often experience different temperature cycles which have an effect on the operational life.

A steam turbine is essentially a continuous-flow machine in which the thermal energy of steam is converted into rotational energy of a rotor. The physical properties of the steam such as, for example, the pressure and temperature are hereby measured and stored as operating data. Other physical properties such as, for example, frequency of rotation, controller output, housing temperatures, etc. are likewise determined and stored as operating data and passed to the control center for processing.

A steam turbine is generally designed for prolonged operation. However, a mode of operation in which the steam turbine is heated up and cooled down many times results in a shortening of the operational life. The condition of the steam turbine should therefore be determined.

To do this, the condition is currently evaluated on the basis of predetermined testing parameters during scheduled inspections. Periodic inspections at which the condition of the steam turbine is monitored are performed with the aid of equivalent operating hours which are predetermined.

The calculation of the equivalent operating hours measures the operating hours from the operation under load and a proportion of the operating hours for taking start-up and shutdown into account.

### SUMMARY OF INVENTION

An object of the invention is to provide a method in which the state of a continuous-flow machine can be monitored.

This is achieved by a method for monitoring a continuous-flow machine, wherein, in a first phase, a first operating property and a second operating property of the continuous-flow machine are measured and a value of the second operating property is associated with each value of the first operating property and stored, wherein an upper maximum value of the second operating property and a lower minimum value of the second operating property are determined for each value of the first operating property, wherein, in a second phase following the first phase, the first operating property and second operating property are determined and a notification is generated when the value of the second operating property falls below the lower value or exceeds the upper value.

The steam turbine has a sealing steam system with a sealing steam controller and the controller output of the sealing steam controller is used as the first operating property, wherein a physical/technical correlation exists between the controller output of the sealing steam controller or sealing steam pressure and the high-pressure wheel chamber pressure of a high-pressure turbine section, wherein the high-pressure wheel chamber pressure is used as the second operating property.

Alternatively, the steam pressure can be used as the first operating property.

The invention is based on the concept that there exists a correlation between two operating properties, in this case a first operating property and a second operating property, which correlation is first determined in the original condition or in other words the fault-free condition. A confidence band in which a maximum and a minimum value are associated with the second operating property is determined for the correlation between the first operating property and the second operating property. This determination is made in an early, fault-free stage of the system. In a later stage during the actual operating phase, the first operating property and the second operating property are determined and as soon as the first operating property falls outside the confidence band, a notification is generated because there is an underlying assumption of a fault in the system.

Advantageous developments are provided in the dependent claims.

In a first advantageous development, the first phase is performed when the machine is put into service. It is important that the first phase is performed in a fault-free system. It is therefore expedient if the first phase takes place whilst the machine is being put into service. A fault-free starting condition is thus defined.

The continuous-flow machine is hereby advantageously designed as a steam turbine.

As an alternative, as long as the steam turbine has a high-pressure and medium-pressure turbine section arranged in a common outer housing, the pressure of the exhaust steam of this medium-pressure turbine section can be used and employed as the second operating property. As a result, a correlation between a first operating property and a second operating property is thus established. A correlation between the high-pressure wheel chamber pressure or medium-pressure exhaust steam pressure and the controller output of the sealing steam controller or the sealing steam pressure is established in a system, in this case a steam turbine in the original condition or starting condition. The sealing steam pressure is employed for the purpose of sealing at the gland seals in order to oppose an external pressure. A change in the turbine clearance entails a change in the relation between the pressure in the sealing steam system and the turbine pressure. A change in the clearance can result, for example, from a displacement of the rotor and the associated larger opening at the sealing tips.

According to the invention, it is proposed to perform, after the putting of the machine into service is complete, a footprint measurement in which a correlation between a first operating property and a second operating property is established. An associated confidence band is furthermore generated from different start-up instances. In this confidence band, an upper maximum value and a lower minimum value of the second operating property are determined. In a later phase which takes place after the machine has been put into service and can be referred to as the operating phase, the data determined whilst the machine is put into service are compared with data which are determined continuously during the operating phase. If the operating data fall outside the confidence range, this can be considered as an indication of a change in clearance and hence as evidence that the shaft gland seal needs to be reconfigured at the next inspection.

The abovedescribed characteristics, features, and advantages of this invention, and the manner in which these are realized, will become clearer and more comprehensible in connection with the following description of the exemplary embodiments which are explained in detail in connection with the drawings.

Exemplary embodiments of the invention are described below with the aid of the drawings.

These show the exemplary embodiments not to scale and instead, as it is for explanatory purposes, the drawing takes a schematic and/or slightly distorted form.

### BRIEF DESCRIPTION OF THE DRAWINGS

Reference is made to the relevant prior art with regard to supplements to the teachings directly observable in the drawings, in which:

The FIGURE shows a correlation between a first operating property and a second operating property.

### DETAILED DESCRIPTION OF INVENTION

The invention relates to a method for monitoring a steam turbine.

A steam turbine as an embodiment of a continuous-flow machine has essentially an outer housing and a rotor mounted rotatably inside the outer housing. An inner housing is generally arranged around the rotor. Steam turbines employed in steam-fired power plants generally have a high-pressure turbine section, a medium-pressure turbine section, and a low-pressure turbine section. There are embodiments in which a high-pressure turbine section and a medium-pressure turbine section are arranged inside a common housing.

In the method according to the invention for monitoring the steam turbine, in a first phase which takes place whilst the machine is being put into service, a first operating property and a second operating property of the steam turbine are measured. A value for the second operating property is associated with each value of the first operating property. The data established in this way, which are also referred to as the footprint, are stored.

In a further step, an upper maximum value for the second operating property and a lower minimum value for the second operating property are determined for each value of the first operating property. This is also referred to as the confidence band.

In a second phase following the first phase, which takes place during the operating phase, the first operating property and the second operating property are continuously determined, wherein this can be effected by a measurement system. The values determined in this way are compared with one another and as soon as the value of the second operating property falls below the lower value or exceeds the upper value, a notification is generated.

The FIGURE shows the correlation between a first operating property 1 and a second operating property 2. A first operating property 1 of the controller output of the sealing steam controller is plotted on the X-axis. Alternatively, a first operating property 1 of the sealing steam pressure can be used.

In the curve 3 shown in the FIGURE, the controller output of the controller is given as a percentage on the X-axis. The range between 0% and 100% is accordingly given for the controller output. A second operating property 2 corresponding to the first operating property 1 is plotted on the Y-axis, and to be precise the high-pressure wheel chamber pressure. Alternatively, the pressure of the exhaust steam of the medium-pressure turbine section can be used where the steam turbine has a high-pressure and medium-pressure turbine section arranged in a common outer housing. The curve 3 shows the correlation between the first operating property 1 and the second operating property 2.

Furthermore, in the FIGURE a lower minimum value 4 and an upper maximum value 5 are given, by way of example, for the value 50% of the first operating property 1. The curve 3 is thus, as it were, framed between a lower minimum value 4 and an upper maximum value 5. This is represented by the dashed line below the curve 3 and the dashed line above the curve 3. The dashed lines thus show a confidence band.

During operation, the operating property 1 and the operating property 2 are measured and, if the second operating property 2 is above the upper maximum value 5 or below the lower minimum value 4, a notification is generated. By means of the notification, notice is given of a change in the shaft gland seal clearance and hence an indication that the gland seal clearance should be monitored as soon as possible in order, for example, to prevent rubbing.

Although the invention has been illustrated and described in detail by means of the preferred exemplary embodiment, the invention is not limited by the examples disclosed and other variants can be derived by a person skilled in the art without going beyond the protective scope of the invention.

1. A method for monitoring a continuous-flow machine, comprising:
in a first phase, measuring a first operating property and a second operating property of the continuous-flow machine and associating and storing a value of the second operating property with each value of the first operating property, and
determining an upper maximum value of the second operating property and a lower minimum value of the second operating property for each value of the first operating property,
in a second phase following the first phase, determining the first operating property and second operating property, and
generating a notification when the value of the second operating property falls below the lower minimum value or exceeds the upper maximum value,
wherein the continuous-flow machine has a sealing steam system with a sealing steam controller and a controller output of the sealing steam controller is used as the first operating property, and
wherein the continuous-flow machine has a high-pressure turbine section and a high-pressure wheel chamber pressure is used as the second operating property.

2. The method as claimed in claim 1,
wherein the first phase takes place while the continuous-flow machine is being put into service.

3. The method as claimed in claim 1,
wherein the continuous-flow machine comprises a steam turbine.

4. The method as claimed in claim 1,
wherein the continuous-flow machine has a sealing steam system with a sealing steam controller and a sealing steam pressure is used as the first operating property.

5. The method as claimed in claim 1,
wherein the continuous-flow machine has a high-pressure and medium-pressure turbine section arranged in a common outer housing and a pressure of an exhaust steam of the medium-pressure turbine section is used as the second operating property.

6. The method as claimed in claim 1,
wherein the upper maximum value of the second operating property and the lower minimum value of the second operating property are stored in a confidence band.

7. The method as claimed in claim 1,
wherein the upper maximum value of the second operating property and the lower minimum value of the second operating property are determined from different start-up instances of the continuous-flow machine.

8. The method as claimed in claim 1,
wherein the second phase takes place during an operating phase.

9. The method as claimed in claim 1,
wherein the values determined in the second phase are determined for the first operating property and the second operating property by a measurement system.

10. A system for monitoring a continuous-flow machine,
wherein the system is adapted to perform the method as claimed in claim 1.
